(19) United States
(12) Patent Application Publication
(10) Pub. No.: US 2007/0157123 A1
(43) Pub. Date: Jul. 5, 2007

(54) CHARACTER STRING PROCESSING METHOD, APPARATUS, AND PROGRAM

(76) Inventors: Yohei Ikawa, Yamato-shi (JP); Hiroshi Kanayama, Yokohama-shi (JP); Daisuke Takuma, Sagamihara-shi (JP)

Correspondence Address: DUKE W. YEE;YEE & ASSOCIATES, P.C., P.O. BOX 802333, DALLAS, TX, 75380, US

(21) Appl. No.: 11/608,602

(22) Filed: Dec. 8, 2006

(30) Foreign Application Priority Data
Dec. 22, 2005 (JP) 2005-370970

(51) Int. Cl. G06F 3/048; G06F 17/27; G06F 17/21; G06F 17/00

(52) U.S. Cl. 715/816; 704/10; 715/534; 704/9

(57) ABSTRACT

In order to solve the above problem, disclosed as a first aspect is a method including the steps of analyzing a character string in a document into partial character strings; calculating, with respect to each of the partial character strings, a score incorporating appearance frequency of the partial character string; presenting the partial character strings and the scores to a user; determining which ones of the partial character strings have been selected by the user; storing the selected partial character strings as a safe partial character string list; and replacing, with predetermined replacement character strings, the partial character strings excluding the partial character strings existing in the safe partial character string list.

### BACKGROUND OF THE INVENTION

1. Field of the Invention:

The present invention relates to a method, a device, and a program for replacing information, which should be kept confidential, in a document with different information.

2. Description of the Related Art:

In recent years, strengthening of technologies for masking (replacing) a character string in a document has been desired from the viewpoint of personal information protection. A technology meeting the desire has been known by which a word to be masked is not displayed by use of a dictionary storing therein character strings which should be masked. For instance, Japanese Patent Application Publication No. 2004-227141 adopts a following masking technique. First, based on a word dictionary, parts to be masked are detected from an inputted document. The detected parts are then presented to a user as a list of masking results to have the user correct the list, and contents of the corrected list serve as final masking subject parts.

With the described method, there is a possibility that there is a masking candidate which cannot be detected because presented words are limited to character strings detected on the basis of the dictionary or rules. In other words, the method is a technology by which final masking candidates are obtained since the user correct detection errors caused by the detection based on the dictionary or rules. In addition, to perform masking of a large amount of document without omission, the dictionary becomes larger in proportion to the amount of the document. Hence, working efficiency is deteriorated because the user needs to correct enormous amount of detection errors. In other words, in the conventional method, consideration has not been given to a document-masking technology enabling efficient masking in a short time in a case where masking of a large amount of document exiting is performed without omission.

In the conventional technology, there has been a problem that a character string which is not in the dictionary cannot appear as a masking candidate. Additionally, consideration has not been given to a mechanism for efficient masking.

### BRIEF SUMMARY OF THE INVENTION

The present invention was made for the purpose of solving the above described technological problems. A first object of the present invention is to provide a document-masking method, device, and program for performing masking without omission.

A second object of the present invention is to provide a mechanism for efficient masking.

A third object of the present invention is to provide a method of, and an apparatus for, masking character strings in a large amount of document in a short time.

A fourth object of the present invention is to provide a method of, and an apparatus for, facilitating selection and replacement of subjects to be masked.

Finally, a fifth object of the present invention is to provide a user, who needs masking, with masking-related services.

With the above objects, the present invention is a method of processing a character string in a document. The method includes the steps of analyzing a character string in a document into partial character strings; calculating, with respect to each of the partial character strings, a score incorporating appearance frequency of the partial character string; presenting the partial character strings and the scores to a user; determining which ones of the partial character strings have been selected by the user; storing the selected partial character strings as a safe partial character string list; and replacing, with predetermined replacement character strings, the partial character strings excluding the partial character strings existing in the safe partial character string list.

With regard to the method, the followings are possible. Each of the partial character strings may be a morpheme. The presenting step may be a step of presenting the partial character strings and the scores to the user in accordance with descending order of the scores. The calculating step may be a step of calculating the score, with respect to each of the partial character strings, by incorporating, into the calculation, the appearance frequency and character string length of the partial character string. Furthermore, the calculating step may be a step of calculating, with respect to each of the partial character strings, the score by incorporating, into the calculation, the appearance frequency, character string length, and any one of a word class in numerical form and a category name in numerical form, all of which are of the character string, the category name being a group to which the character string belongs. The method of the present invention may be configured to further include a step of calculating, with respect to each of the partial character strings, a risk with which the partial character string is regarded as a risky character string. In the configuration, the presenting step is a step of presenting the partial character strings, the scores, and the risks of the partial character strings to the user. Here, the risks are calculated into higher values, with respect to partial character strings included in a risky character string list in which risky character strings are previously stored. The presenting step may further include a step of presenting the partial character strings, each of which has the risk with a value lower than a predetermined value, as the partial character strings already selected. Furthermore, the presenting step may further include a step of presenting the replacement character strings of the respective partial character strings. The presenting step may further include a step of presenting broader terms of the partial character strings as the replacement character strings by using a category dictionary in which the broader terms of the partial character strings are stored. Lastly, the determining step may further include a step of accepting editing of the replacement character string.

In addition, the present invention can also be understood as a program which causes a computer to realize predetermined functions. In this case, the program of the present invention causes a computer to realize the functions of analyzing a character string in a document into partial character strings; calculating, with respect to each of the partial character strings, a score incorporating appearance frequency of the partial character string; presenting the partial character strings and the scores to a user; determining which ones of the partial character strings have been selected by the user; storing the selected partial character strings as a safe partial character string list; and replacing, with predetermined replacement character strings, the partial character strings excluding the partial character strings existing in the safe partial character string list.

With the present invention, it becomes possible to efficiently perform document-masking, whereby a large amount of document can be masked in a short time. Additionally, selection of character strings to be masked and editing of replacement character strings can be performed with ease.

### BRIEF DESCRIPTION OF THE SEVERAL VIEWS OF THE DRAWINGS

For a more complete understanding of the present invention and the advantage thereof, reference is now made to the following description taken in conjunction with the accompanying drawings.

FIG. 1 is a diagram showing a configuration of a system of an embodiment.

FIG. 2 is a diagram schematically showing a hardware configuration of a computer realizing the embodiment.

FIG. 3 is a diagram showing a more detailed configuration of a score calculation section 130.

FIG. 4 is a diagram showing a more detailed configuration of a partial character string presentation section 140.

FIG. 5 is a flowchart of a safe character string list generating section.

FIG. 6 is a view showing an user interface of a partial character string check main screen.

FIG. 7 is a view showing a user interface of detailed-information display screen.

### DETAILED DESCRIPTION OF THE INVENTION

Hereinafter, by referring to the attached drawings, the best mode (hereinafter, referred to as “the embodiment”) of the present invention will be described in detail. In the following, if each partial character string is a morpheme, a word, a clause, a sentence or a display letter type in the embodiment, the embodiment can be carried out without affecting the essence of the present invention whatever the each is.

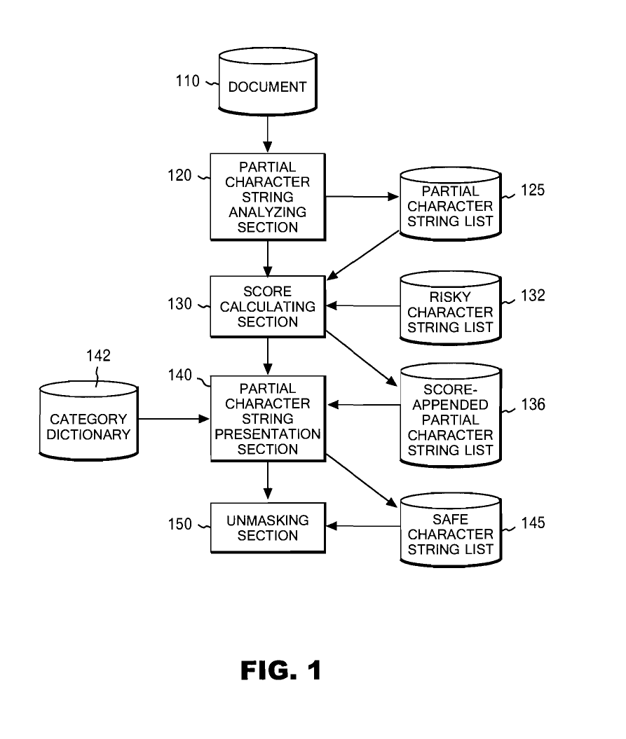

FIG. 1 is a diagram showing a system configuration of the embodiment. A document 110 is a document mainly constituted of text. In the text, there are character strings which should be kept confidential. The character strings are eventually masked in accordance with the present invention. A partial character string analyzing section 120 analyzes the read-in text into partial character strings. As analyzing method, well known are those with which text is analyzed into morphemes, words, clauses, sentences, or display letter types. Favorably, it is desirable that the text be analyzed into morphemes. Note that, since methods for morphological analysis are publicly known, details of the methods will be omitted here. The partial character strings obtained after the analysis are stored in a partial character string list 125. Note that all of character strings are in a state of being masked first, not as in the case of the conventional technique. Partial character strings regarded as safe are unmasked, and character strings regarded as risky are replaced respectively with predetermined replacement character strings. A score calculating section 130 calculates a score and a risk of each partial character string. The score is in numerical form, and shows how important the partial character string is. The score is calculated mainly from appearance frequency and character string length of the partial character string. However, the score may be calculated by incorporating a value of the risk in numerical form, which will be described later, and any one of word-class name and category name (described later in detail) of the partial character string. The risk denotes a risk of leakage of confidential information due to the unmasking of the partial character strings. The risk is defined as a binary value in a manner that the risk is regarded as “1” when the partial character string is stored in a risky character string list 132, and that the risk is regarded as “0” otherwise. In a different manner, a certainty factor is given with which the partial character string is certainly regarded as risky. Note that the risky character string list is generated by utilizing existing personal names, geographic names, company names and the like. The scores and risks of the partial character strings are stored as a score-appended partial character string list 136. A partial character string presentation section 140 presents, to a user, the sores and risks calculated by the score calculating section 130, and makes the user select the partial character strings to be unmasked. With the partial character string presentation section 140, the user can also determine which replacement character strings the partial character strings should be replaced with. Defaults are provided beforehand as the replacement character strings. However, if a category dictionary 142 storing therein broader terms of the partial character strings includes the broader term of one of the character strings, the broader term can be selected as the replacement character string of the character string with reference to the category dictionary 42. Additionally, the replacement character strings can be edited by instructions of the user. Results of the selection and editing with the partial character string presentation section 140 are stored as a safe character string list 145. Partial character strings, such as specific product names, are stored in the safe character string list 145. It is previously determined that the character strings are safe. Accordingly, the number of checks by the user can be smaller. An unmasking section 150 unmasks masked partial character strings in the document based on the safe character string list. That is, the unmasking section 150 replaces, with predetermined replacement character strings, all of the partial character strings excluding those existing in the safe character string list 145. The processed document is immediately displayed on a display apparatus 275 with an unmasking rate. If the user finds the unmasking insufficient after checking whether desired unmasking has been performed, the user can further repeat with ease the operation of selection and editing. Therefore, the user can very smoothly obtain a desired replacement result.

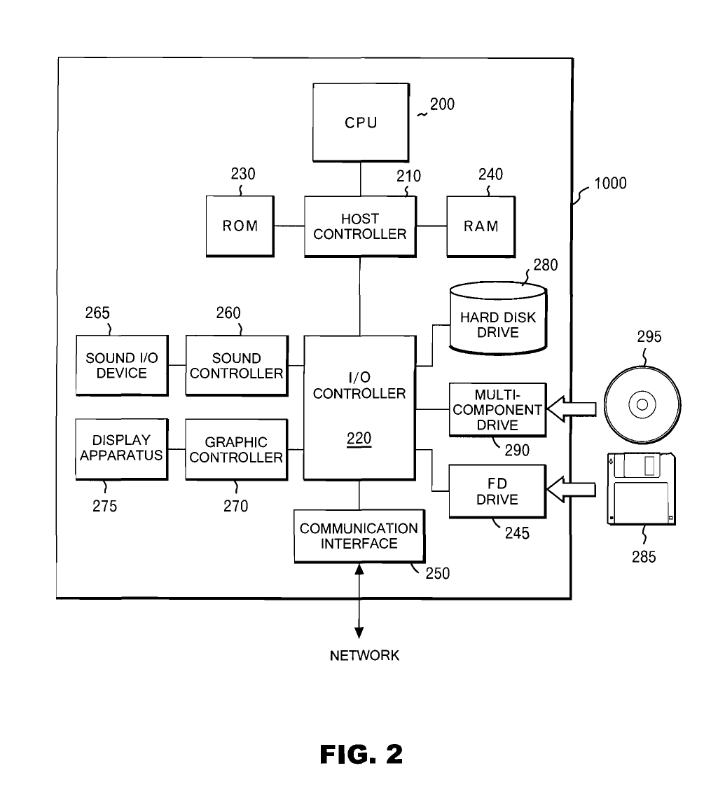

FIG. 2 is a diagram schematically showing an example of a hardware configuration of a computer, which is favorable for being used as the embodiment. A computer 1000 includes a CPU peripheral section having a CPU 200, a RAM 240, a ROM 230 and an I/O controller 220 all of which are mutually connected by a host controller 210. The computer 1000 also includes a communication interface 250, a hard disk drive 280, a multi-component drive 290, an FD drive 245, a sound controller 260 and a graphic controller 270, all of which are connected to the I/O controller 220. The multi-component drive 290 is capable of reading from and writing in a disc-type medium 295 such as a CD or DVD. The FD drive 245 is capable of reading from and writing in a flexible disk 285. The sound controller 265 drives a sound I/O device 265. The graphic controller 270 drives the display apparatus 275.

The CPU 200 operates based on programs stored in the ROM 230, a BIOS and the RAM 240, and thereby controls the sections. The graphic controller 270 acquires image data, which is generated by the CPU 200 or the like, on a frame buffer provided in the RAM 240, and displays the image data on the display apparatus 275. Otherwise, the graphic controller 270 may include therein a frame buffer in which the image data generated by the CPU 200 or the like is stored. Favorably, partial character strings to be masked are displayed on the display apparatus 275 to prompt the user to make a selection from the partial character strings.

The communication interface 250 communicates with an external communication apparatus via a network. Favorably, the CPU 200 is configured to receive a document from a user via the communication interface 250, to perform desired replacement by using a character string replacing apparatus of the present invention, and to then transmit to the user a result of the replacement, the user desiring to have the document masked. Note that it is possible to use a network by cable, by radio, by infrared ray, or by short-range radio such as Bluetooth without changing the configuration of the present application at all. The hard disk drive 280 stores therein codes and data of a program, an application, an OS, and the like of the present invention, all of which are used by the computer 1000. The multi-component drive 290 reads out a program or data from the medium 295 such as a CD or DVD. Then, the program or data read out from any one of these storage devices is loaded into the RAM 240, and is utilized by the CPU 200. A medium in which a program of the present invention is stored may be provided from any one of the external storage media. Alternatively, the medium may be provided by being downloaded via the internal hard disk drive 280 or the network. Preferably, the partial character string list 125, the risky character string list 132, the score-appended partial character string list 136 and the safe character string list 145 are stored in the hard disk drive 250.

The program presented above may be stored in an external storage medium. Besides the flexible disk 285 and an CD-ROM, the following may be used as the storage medium: an optical recording medium such as a DVD or a PD, a magnetooptical recording medium such as an MD, a tape medium, a semiconductor memory such as an IC card, or the like. In addition, the program may be taken in via the network by using, as the recording medium, a storage device such as a hard disk or a RAM provided in a server system attached to a dedicated communication network or the Internet. As can be understood from the example of the above configuration, any hardware including usual computer functions is usable as the hardware necessary to the present invention. For instance, even a mobile terminal, a portable terminal, or a household electrical appliance is usable without any problem.

Incidentally, FIG. 2 is nothing more than schematically showing a hardware configuration of a computer realizing the present embodiment, and any of other various configurations can be taken as long as the embodiment is applicable to the one.

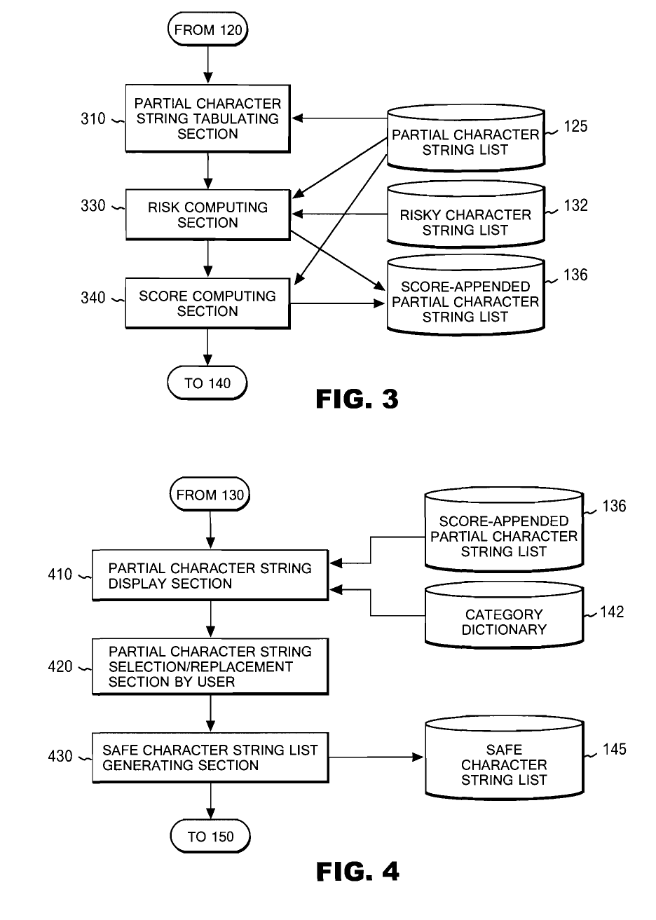

FIG. 3 is a diagram showing a more detailed configuration of the score calculating section 130. Based on the partial character string list 125 generated by the partial character string analyzing section 120, a partial character string tabulating section 310 tabulates basic data including appearance frequencies of the respective partial character strings.

Next, a risk computing section 330 computes the risk of each partial character string. The risk (R) is in numerical showing a risk of leakage of confidential information, the risk resulting from unmasking of the partial character string. The risk is defined as “1” if that partial character string is listed among the partial character strings stored in the risky character string list 132, and the risk is defined as “0” otherwise. Alternatively, a certainty factor with which the partial character string is defined as risky may be assigned by using a particular index. Note that the risky character string list is generated by utilizing existing dictionaries of personal names, geographic names, company names and the like. Outputs of the risk computing section 330 are stored in the score-appended partial character string list 136 with respect to each partial character string.

A score computing section 340 computes the score of each partial character string. The score is in numerical form showing how important the partial character string is in the document. The score of the partial character string is calculated based on an appearance frequency (A), a partial character string length (B), any one of a word-class name (C) and a category name (D), and the risk (R) described above, of the partial character string. A computation formula for the score (S) is shown below. Note that the calculation formula is exemplification, and can be changed variously depending on a kind of the document, a checking environment and the like. Outputs of the score computing section 340 are stored in the score-appended partial character string list 136.

S=A×B×(C+D)+R

FIG. 4 is a diagram showing a more detailed configuration of the partial character string presentation section 140. A partial character string display section 410 reads the score-appended partial character string list 136, and displays, onto the display apparatus 275, the scores, the word classes, the appearance frequencies, the risks and the replacement character strings of the respective partial character strings. Although predetermined character strings are provided beforehand as defaults of replacement character strings, broader terms of the partial character strings can be selected as the replacement character strings with reference to the category dictionary 142 storing therein the broader terms of the partial character strings. A partial character string selection/replacement section 420 accepts, from the user, selection of unmasking of desired partial character strings, and also accepts corrections of the replacement character strings. A user interface of the partial character string presentation section 410 and the partial character string selection/replacement section 420 will be described later in detail. Next, a safe character string list generating section 430 generates a final safe character string list on reception of a result of the partial character string selection/replacement section 420. The result of the generation is stored in the safe character string list 145.

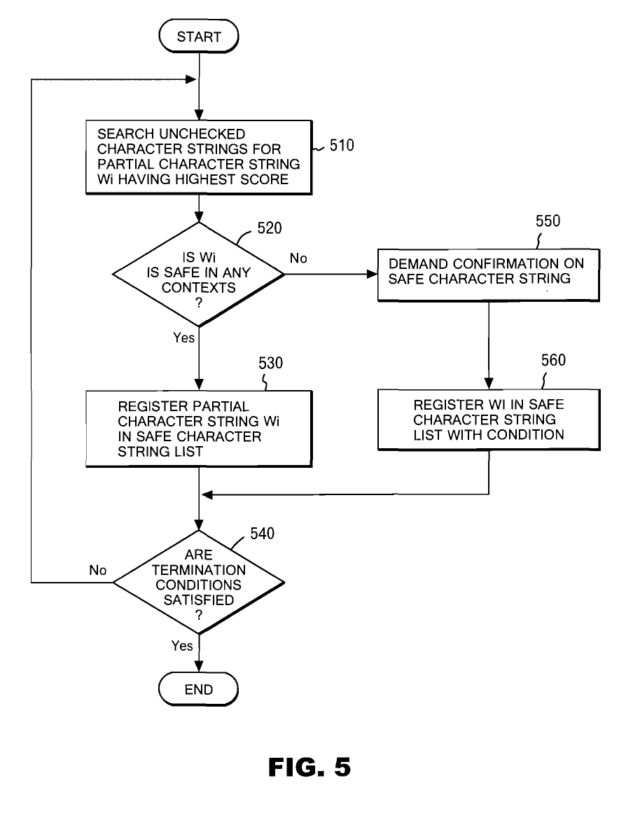

FIG. 5 is a chart in which processing of the safe character string list generating section 430 is shown in the form of a flowchart. First of all, an internal format of the generated safe character string list 145 will be described. The safe character string list 145 is a list of safe character strings for which a replacement process is not required. Additionally, a safe character string can be specified with a condition, for instance, in such a manner that “the specified certain character string is not constantly a safe character string, but is a safe character string in the case of appears beside a certain character string.” In the following, names of entries, and meanings of the entries will be exemplified.

Entry name Meaning of entry

Internet “Internet” is constantly a safe character string;

Internet {connection (a noun)} A safe character string when the noun “connection” comes after “Internet”;

{wo (a Japanese postposition)} Internet A safe character string when the Japanese postposition “wo” comes before “Internet”;

{a postposition Internet {a postposition} A safe character string when postpositions come respectively before and after “Internet”

In Step 510, unchecked character strings are searched for a partial character string Wi having the highest score. In Step 520, a user is prompted to determine, based on information such as the word class and the risk of the character string Wi, whether the character string Wi is safe in any contexts. If the character string Wi is safe in any contexts, the processing moves on to Step 530, where the partial character string Wi is registered in the safe character string list 145. If the character string Wi is not safe, a detailed information display screen 615 is displayed to the user, and thus the user is prompted to make confirmation on unmasking for the safe pattern by taking surroundings information of the partial character string Wi into consideration. Once the user has confirmed, by referring to the surroundings information of the character string Wi and the like, that the partial character string Wi is a safe character string, the partial character string Wi is stored in the safe character string list 145 with a condition. Thereafter, the processing moves on to Step 540. The partial character string Wi is excluded from those to be unmasked if the user does not determine that the partial character string Wi is safe. In Step 540, it is determined whether termination conditions are satisfied. Termination of the processing is determined on the basis of a number of partial character strings which should be checked, and additionally on the basis of an unmasking rate.

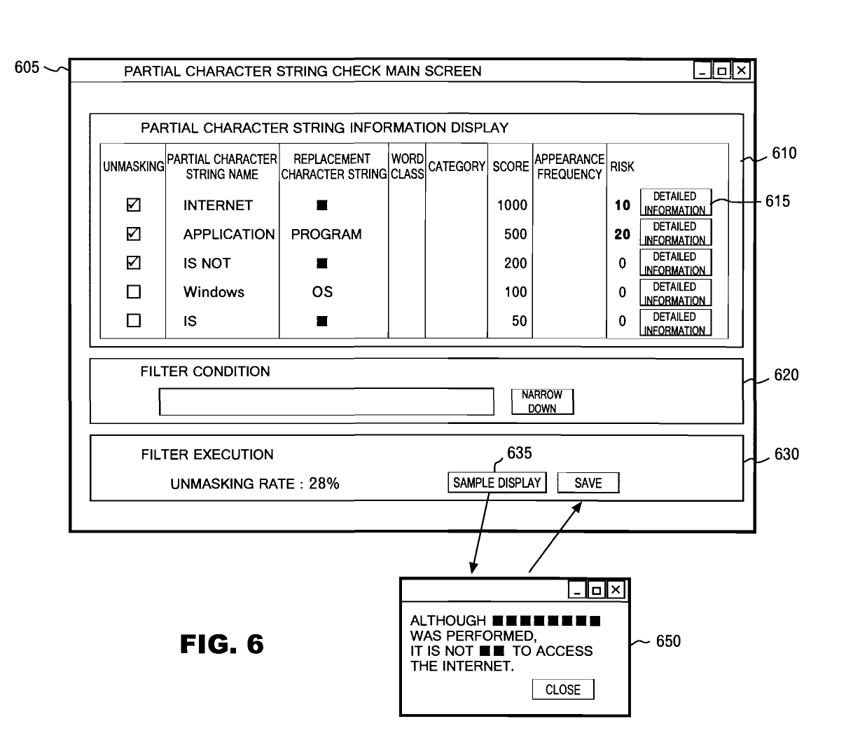

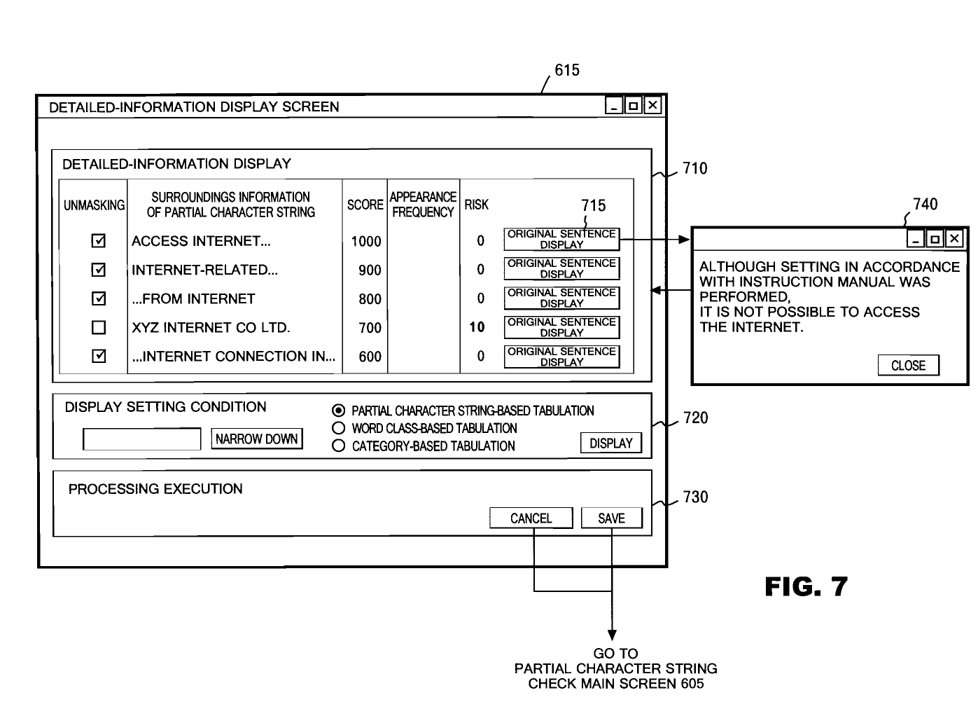

FIGS. 6 and 7 are examples of display screen showing user interfaces of the partial character string presentation section 140. There are two main types of display screens presented to a user. A display screen of one type is a partial character string check main screen 605 shown in FIG. 6, and a display screen of the other type is a detailed-information display screen 615 shown in FIG. 7. Furthermore, the partial character string check main screen 605 is constituted of three regions which are a partial character string information display portion 610, a filter condition portion 620 and a filter execution portion 630. The partial character string information display portion 610 includes selection/deselection of unmasking, names of partial character strings, replacement character strings, word classes, categories, scores, appearance frequencies, risks, and detailed-information display buttons, and accordingly the user can make a selection or deselection of unmasking with respect to all of the partial character strings. Additionally, default characters (filled squares in FIG. 6) are prepared as the replacement character strings. However, if a broader term for a certain partial character string is found existing in the category dictionary 142, the broader term can be presented as the replacement character string of the partial character string by use of the category dictionary. Note that the replacement character strings can be edited into character strings which the user desires. The partial character strings are presented in accordance with descending order of the scores. Preferably, partial character strings with the risks having values lower than a predetermined value are regarded as safe, and thus are displayed as those for which selection of unmasking is already made. The user can know detailed information of any of the partial character strings by selecting the corresponding detailed-information button 615. The user can narrow down the partial character strings by inputting a search keyword in the filter condition portion 620. Additionally, with the filter execution portion 630, the user can have a sample display 650 displayed. The unmasking rate in the filter execution portion 630 indicates what percentage of characters in the document are not masked (replaced).

When the user selects the detailed-information button 615 of one of the partial character strings, more detailed information of that partial character string is displayed as shown in FIG. 7. In FIG. 7, surroundings information and selection of unmasking, and are displayed with respect to the partial character string “Internet.” Furthermore, an original sentence of the partial character string is displayed in an original sentence window 740 by selecting an original sentence display button 715. As described, it is possible in the present invention to set unmasking individually even for cases of the single partial character string “Internet” by referring to surroundings information (contexts) of the respective cases. The user can narrow down contents in a detailed-information display portion 710 by inputting a search keyword in a display setting condition portion 720. Additionally, as a manner of tabulation, the user can change an order in which the partial character strings are displayed by selecting the partial character strings, the word class or the categories. Here, the categories are groups each having partial character strings as elements of the each, and have category names corresponding to contents of the respective categories. In the following, an example of the category names, and examples of the elements contained in the corresponding category thereof will be shown.

Name of category Elements

Notebook computer B series 01, B series 02

Additionally, as a manner of tabulation, the user can change the order in which the partial character strings are displayed by selecting among the partial character strings-based tabulation, the word-class-based and category-based tabulation. Here, categories are groups each having partial character strings as elements of the each, and have category names corresponding to contents of the respective categories. In the following, an example of the category name, and examples of the elements contained in the corresponding category will be shown.

Name of category Elements

Notebook computer B series 01, B series 02.

Additionally, it is also possible to manage the categories by generating tree structures with the respective categories being set as nodes. In this case, in the tree structures generated, each category serving as a parent node includes elements of the categories serving as the child nodes. In the following, examples of the tree structure of categories are shown:

Desktop computer={A series 01, A series 02}

Notebook computer={B series 01, B series 02}

Peripheral apparatuses={printer, scanner}

Computer={A series 01, A series 02, B series 01, B series 02}

Products={A series 01, A series 02, B series 01, B series 02, printer, scanner}

Categories managed in the form of tree structures as described above are stored in the category dictionary 142 used in the present invention, whereby categories which are broader in meaning are presented as the replacement character strings as in the case with a concept dictionary. Although the categories as they are can be accepted as the replacement character strings, it is needless to say that they can be changed as appropriate in accordance with instructions by the user. After the completion of selection through the detailed-information display portion 710 or the display setting condition portion 720, the setting is saved through a processing execution portion 730. Thereafter, the display returns to the partial character string check main screen 605.

The document-masking method of the present invention can bring about a considerable decrease in labor costs because the method makes it possible to check partial character strings tabulated beforehand, instead of checking partial character strings in the order of appearance in a document.

As an actual example, the present invention was applied to logs of a call center. As a result, approximately 1.8 million partial character strings were extracted from the whole document with approximately 3 million characters. In a case where unique partial character strings thereof counting approximately 30 thousands were checked in descending order of the scores thereof, checking the top 1400 partial character strings (4.7%) in the scores implied checking of 80% of the whole document. In this case, checking the top 3800 partial character strings (12.7%) in the scores implied checking of 90% of the whole document. Next, by assuming that no partial character string which should be masked exists, a study was performed to know how much character strings should be unmasked to obtain usable information emerging. As a result, information of the document became gradually understandable with the increasing rate of partial character strings unmasked, and it was confirmed that sufficiently usable information emerges when roughly 80 to 90% of all of the character strings are unmasked. In reality, it is required to unmask partial character strings with attention to partial character strings which can be risky character strings. Nevertheless, in comparing with each other a case of checking the 1.8 million partial character strings in the order of appearance, and a case of checking approximately 4000 partial character strings, it is obvious that the latter case, that is, the method of the present invention can keep labor costs at a lower level. Applied examples of the present invention will be shown in the following.

In order to make use of call logs at a customer support center or the like, for example, in planning of marketing strategies, the call logs are made usable by safely masking confidential information therein in a short time. In a situation of this kind, it is possible to utilize the present invention. First, before performing masking of the call logs by using the present invention, partial character strings found not being risky character strings are kept stored in the safe character string list 145.

In order to enable more people to read a document shared by a certain community, or a mail sent to a mailing list, it is possible to perform masking by utilizing the present invention. In this case, in particular, partial character personal strings which are personal names and company names are kept stored beforehand in the risky character string list 132. For instance, utilization of the present invention is considered possible in a case where a confidential document is disclosed in compliance with the information disclosure system after safely performing masking of the document.

At a medical site, the present invention is applicable to research on a decision making system for deciding what kind of treatment should be given to a patient by collecting information such as medical records of patients. Since the medical records includes highly confidential personal information, it is necessary to take out therefrom information such as a disease name, checked items and results thereof, medicines being given, results of treatments while masking character strings with which a person can certainly be specified as the patient. In this case, the safe character string list 145 is generated beforehand by using technical term dictionaries including disease names and medicines listed. Additionally, storing partial character personal strings, which are personal names or organizations, are stored in the risky character string list 132 to perform masking of the document with the method of the present invention.

Although the preferred embodiment of the present invention has been described in detail, it should be understood that various changes, substitutions and alternations can be made therein without departing from spirit and scope of the inventions as defined by the appended claims.

1. A method of processing a character string in a document, the method comprising the steps of:
analyzing a character string in a document into partial character strings;
calculating, with respect to each of the partial character strings, a score incorporating appearance frequency of the partial character string, whereby a set of scores is formed;
presenting the partial character strings and the set of scores to a user;
determining which ones of the partial character strings have been selected by the user to form selected partial character strings;
storing the selected partial character strings as a safe partial character string list; and
replacing the partial character strings with predetermined replacement character strings, wherein the partial character strings existing in the safe partial character string list are excluded from being replaced.

2. The method according to claim 1, wherein each of the partial character strings is a morpheme.

3. The method according to claim 1, wherein the presenting step comprises presenting the partial character strings and the set of scores to the user in accordance with a descending order of the set of scores.

4. The method according to claim 1, wherein the calculating step comprises calculating the score, with respect to each of the partial character strings, by incorporating, into a calculation, the appearance frequency and a character string length of each of the partial character strings.

5. The method according to claim 1, wherein the calculating step comprises calculating, with respect to each of the partial character strings, the score by incorporating, into calculation, the appearance frequency, a character string length, and any one of a word class in numerical form and a category name in numerical form, all of which are of the character strings, the category name being a group to which the character strings belong.

6. The method according to claim 1, further comprising:
calculating, with respect to each of the partial character strings, a risk to form a set of risks, wherein the presenting step comprises presenting the partial character strings, the set of scores, and the set of risks to the user.

7. The method according to claim 6, wherein the set of risks are calculated into higher values with respect to partial character strings included in a risky character string list in which risky character strings are previously stored.

8. The method according to claim 6, wherein the presenting step further comprises presenting a group of partial character strings, wherein each partial character string in the group has a risk with a value lower than a predetermined value, as the selected partial character strings.

9. The method according to claim 1, wherein the presenting step further comprises presenting the replacement character strings of the respective partial character strings.

10. The method according to claim 9, wherein the presenting step further comprises presenting broader terms of the partial character strings as the replacement character strings by using a category dictionary in which the broader terms of the partial character strings are stored.

11. The method according to claim 10, wherein the determining step further comprises accepting editing of the replacement character strings.

12. A character string processing apparatus comprising:
means which analyzes a character string in a document into partial character strings;
means which calculates, with respect to each of the partial character strings, a score incorporating appearance frequency of the partial character string, whereby a set of scores can be formed;
means which presents the partial character strings and the set of scores to a user;
means which determines which ones of the partial character strings have been selected by the user to form selected partial character strings;
means which stores the selected partial character strings as a safe partial character string list; and
means which replaces the partial character strings with predetermined replacement character strings wherein the partial character strings existing in the safe partial character string list are excluded from being replaced.

13. A computer program in a storage medium for processing a character string in a document, wherein the computer program causes a computer to perform the steps of:
analyzing a character string in a document into partial character strings;
calculating, with respect to each of the partial character strings, a score incorporating appearance frequency of the partial character string whereby a set of scores is formed;
presenting the partial character strings and the set of scores to a user;
determining which ones of the partial character strings have been selected by the user to form selected partial character strings;
storing the selected partial character strings as a safe partial character string list; and
replacing the partial character strings with predetermined replacement character strings, wherein the partial character strings existing in the safe partial character string list are excluded from being replaced.

14. A method of processing a character string in a document, the method comprising the steps of:
receiving a document;
analyzing a character string in a document into partial character strings;
calculating, with respect to each of the partial character strings, a score incorporating appearance frequency of the partial character string, whereby a set of scores is formed;
presenting the partial character strings and the set of scores to a user;
determining which ones of the partial character strings have been selected by the user to form selected partial character strings;
storing the selected partial character strings as a safe partial character string list;
replacing the partial character strings with predetermined replacement character strings, wherein the partial character strings existing in the safe partial character string list are excluded from being replaced; and
transmitting the document.

15. The method according to claim 14, wherein each of the partial character strings is a morpheme.

16. The method according to claim 14, wherein the calculating step comprises calculating the score, with respect to each of the partial character strings, by incorporating, into a calculation, the appearance frequency and a character string length of each of the partial character strings.

17. The method according to claim 14, wherein the calculating step comprises calculating, with respect to each of the partial character strings, the score by incorporating, into calculation, the appearance frequency, a character string length, and any one of a word class in numerical form and a category name in numerical form, all of which are of the character strings, the category name being a group to which the character strings belong.

18. The method according to claim 14, further comprising:
calculating, with respect to each of the partial character strings, a risk to form a set of risks, wherein the presenting step comprises presenting the partial character strings, the set of scores, and the set of risks to the user.

19. The method according to claim 18, wherein the set of risks are calculated into higher values with respect to partial character strings included in a risky character string list in which risky character strings are previously stored.

20. The method according to claim 18, wherein the presenting step further comprises presenting a group of partial character strings, wherein each partial character string in the group has a risk with a value lower than a predetermined value, as the selected partial character strings.
